(19) United States
(12) Patent Application Publication
(10) Pub. No.: US 2015/0341362 A1
(43) Pub. Date: Nov. 26, 2015

(54) METHOD AND SYSTEM FOR SELECTIVELY PERMITTING NON-SECURE APPLICATION TO COMMUNICATE WITH SECURE APPLICATION

(71) Applicant: OpenPeak Inc., Boca Raton, FL (US)

(72) Inventors: Andrew James Dobson, McKinney, TX (US); David Medina, Palmetto Bay, FL (US)

(21) Appl. No.: 14/669,911

(22) Filed: Mar. 26, 2015

Related U.S. Application Data
(60) Provisional application No. 61/973,898, filed on Apr. 2, 2014.

(51) Int. Cl. H04L 29/06; H04L 29/08

(52) U.S. Cl. CPC H04L 63/10; H04L 67/10

(57) ABSTRACT

A method and system of selectively permitting a non-secure application to communicate with a secure application are described herein. The method can be practiced in a system that support an environment designed to restrict secure applications from processing requests from non-secure applications. In particular, a request can be received from a non-secure application by a system framework and, through the system framework, it can be determined that a secure application is capable of processing the request. The request can be delegated from the system framework to a secure framework. In addition, through the secure framework, it can be determined whether the non-secure application is an authorized non-secure application. If the non-secure application is an authorized non-secure application, the secure application can be permitted to process the request from the non-secure application.

### CROSS-REFERENCE TO RELATED APPLICATIONS

This patent application claims priority to U.S. Provisional Patent Application No. 61/973,898, filed on Apr. 2, 2014, which is incorporated herein by reference in its entirety.

### FIELD OF TECHNOLOGY

The present description relates to methods and systems for enabling communications between applications and more particularly, for enabling communications between non-secure applications and secure applications.

### BACKGROUND

In an effort to increase productivity, many employers allow their workers to conduct business related to the employer on their personal mobile devices. In some cases, employers also provide some of their employees with company-issued mobile devices. In either arrangement, an employer understands that a single device may include sensitive data related to that employer in addition to data that is personal to the employee. Several advances have been made in an effort to protect an employer's data in these circumstances. For example, OpenPeak Inc. of Boca Raton, Fla. has developed solutions that enable a mobile device to include both enterprise and personal data but that isolate the enterprise data from the personal data. As part of these solutions, an employee may download secure applications that may be used to conduct transactions related to the enterprise, but these secure applications are prevented from exchanging data with conventional or non-secure applications.

These secure applications are typically altered to enable management of the applications and for security purposes, a process sometimes referred to as “wrapping” or “adapting” the application. In certain cases, an application is wrapped by manipulating the binary of the application and inserting adaptive code in the application to enable the interception of calls to and from the application. This process can increase the functionality of the application and can make it secure, as described above.

In some cases, the secure applications may be designated for inclusion in a secure partition. Steps can be taken to encapsulate the internal communications of the secure applications in the secure partition, such as by creating an unpredictable namespace for these communications. Through namespace enforcement, a non-secure application is prevented from accessing data from or communicating with a secure application, even if the non-secure application is the same version as the secure application.

### SUMMARY

A method of selectively permitting a non-secure application to communicate with a secure application is described herein. The method can be practiced in an environment designed to restrict secure applications from processing requests from non-secure applications. A request can be received from a non-secure application by a system framework, and it can be determined, through the system framework, that a secure application is capable of processing the request. The request can be delegated from the system framework to a secure framework, and through the secure framework, it can be determined whether the non-secure application is an authorized non-secure application. If the non-secure application is an authorized non-secure application, the secure application can be permitted to process the request from the non-secure application. In contrast, a request denial can be returned to the non-secure application if the non-secure application is not an authorized non-secure application.

In one embodiment, the process of determining, through the secure framework, whether the non-secure application is an authorized non-secure application can include determining whether the non-secure application is part of an application whitelist. As an example, the application whitelist may be unique to the secure application or may be assigned to the secure application and other secure applications. As another example, the application whitelist may be a dynamic whitelist, and one or more updates to the application whitelist can be received such that non-secure applications are added to or removed from the application whitelist.

In another embodiment, a new request can be received from the non-secure application, and the process of determining whether the non-secure application is an authorized non-secure application can be repeated before permitting the secure application to process the new request from the non-secure application. As an alternative, when a new request is received from the non-secure application, it can be determined whether the new request satisfies a grace period threshold. If the new request satisfies the grace period threshold, the secure application can be permitted to process the new request without determining whether the non-secure application is part of the application whitelist.

A method of selectively enabling application requests is described herein. For example, on a computing device that supports an environment that is designed to restrict secure applications from processing requests from non-secure applications, an application whitelist can be received and stored at the computing device. A request from a non-secure application can be received, and it can be determined that a secure application is capable of processing the request from the non-secure application. It may also be determined whether the non-secure application is part of the application whitelist. If the non-secure application is part of the application whitelist, the secure application can be permitted to process the request from the non-secure application. As an example, the application whitelist can be stored in a database that is associated with a secure personal information manager (PIM) application. As another example, updates to the application whitelist can be received from a remote portal.

In one arrangement, certain components associated with the secure application may have intercepts imposed on them and at least some of the components associated with the secure application that have not had intercepts imposed on them can be registered with a system framework of the computing device. In addition, the secure application can interact with a secure framework, and the process of determining whether the non-secure application is part of the application whitelist can be performed through the secure framework. The computing device can also have a personal workspace and a secure workspace. The non-secure application can be part of the personal workspace, and the secure application can be part of the secure partition. Also, the non-secure application can be associated with personal data of a user of the computing device, and the secure application is associated with enterprise data.

A computing device is also described herein. The computing device can include an input device that is configured to accept input from a user that enables the user to launch both secure and non-secure applications. Additionally, the computing device may support an environment that is designed to restrict the secure applications from processing requests from the non-secure applications. The computing device may include memory that is configured to store an application whitelist that identifies authorized non-secure applications and may also include one or more processing units. The processing unit may be configured to facilitate the determination that a secure application is capable of processing a request from a non-secure application, facilitate the determination that the requesting non-secure application is part of the application whitelist, and facilitate the secure application processing the request from the non-secure application if the non-secure application is identified as part of the application whitelist.

The processing unit can be further configured to facilitate the determination that the secure application is capable of processing the request from the non-secure application through a system framework that is part of the computing device. In another arrangement, the processing unit can be further configured to facilitate the determination that the requesting non-secure application is part of the application whitelist through a secure framework that is part of the computing device.

As an example, the application whitelist may be unique to the secure application or may be assigned to the secure application and other secure applications. The computing device can also include an interface that is configured to receive one or more updates to the application whitelist such that non-secure applications are added to or removed from the application whitelist.

In another arrangement, the processing unit is further configured to facilitate the registration of certain predetermined components of the secure application with a system framework of the computing device. The computing device may also be configured to support a personal workspace and a secure workspace. The non-secure application may be part of the personal workspace, and the secure application may be part of the secure workspace.

A non-transitory computer readable storage medium is also described herein. The non-transitory computer readable storage medium may have instructions stored thereon that may cause a computing device to execute certain actions when the non-transitory computer readable storage medium is installed or loaded on the computing device. The computing device may support an environment that is designed to restrict secure applications from processing requests from non-secure applications. The actions that the computing device may take include the following: receiving an application whitelist; storing the application whitelist at the computing device; receiving a request from a non-secure application; determining that a secure application is capable of processing the request from the non-secure application; determining whether the non-secure application is part of the application whitelist; and if the non-secure application is part of the application whitelist, permitting the secure application to process the request from the non-secure application.

Further features and advantage, as well as the structure and operation of various embodiments, are described in detail below with reference to the accompanying drawings. It is noted that this description is not limited to the specific embodiments presented herein. Such embodiments are provided for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the subject matter described herein and, together with the description, further serve to explain the principles of such subject matter and to enable a person skilled in the relevant art(s) to make and use the subject matter.

FIG. 1 illustrates an example of a system for the distribution of applications to computing devices.

FIG. 2 illustrates an example of a block diagram of the system architecture of a computing device.

FIG. 3 illustrates an example of a method for selectively permitting a non-secure application to communicate with a secure application.

FIG. 4 illustrates an example of portion of the system architecture of FIG. 2.

Applicants expressly disclaim any rights to any third-party trademarks or copyrighted images included in the figures. Such marks and images have been included for illustrative purposes only and constitute the sole property of their respective owners.

The features and advantages of the embodiments herein will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

The following detailed description refers to the accompanying drawings that illustrate exemplary embodiments; however, the scope of the present claims is not limited to these embodiments. Thus, embodiments beyond those shown in the accompanying drawings, such as modified versions of the illustrated embodiments, may nevertheless be encompassed by the present claims.

References in the specification to “one embodiment,” “an embodiment,” “an example embodiment,” “one arrangement,” “an arrangement” or the like, indicate that the embodiment or arrangement described may include a particular feature, structure, or characteristic, but every embodiment may not necessarily include the particular feature, structure, or characteristic. Moreover, such phrases are not necessarily referring to the same embodiment or arrangement. Furthermore, when a particular feature, structure, or characteristic is described in connection with an embodiment or arrangement, it is submitted that it is within the knowledge of one skilled in the art to implement such feature, structure, or characteristic in connection with other embodiments or arrangements whether or not explicitly described. The word “among,” as it is used throughout this description, should not necessarily be interpreted as requiring exchanges or interaction among three or more applications, irrespective of grammar rules. The word “a” is not necessarily limited to a singular instance of something, as it may mean one or more.

Several definitions that apply throughout this document will now be presented. The term “exemplary” as used herein is defined as an example or an instance of an object, apparatus, system, entity, composition, method, step or process. The term “communicatively coupled” is defined as a state in which two or more components are connected such that communication signals are able to be exchanged (directly or indirectly) between the components on a unidirectional or bidirectional (or multi-directional) manner, either wirelessly, through a wired connection or a combination of both. A “computing device” is defined as a component that is configured to perform some process or function for a user and includes both mobile and non-mobile devices. The term “computer readable storage medium” is defined as one or more components that are configured to store instructions that are to be executed by one or more processing units.

An “application” is defined as a program or programs that perform one or more particular tasks on a computing device. Examples of an application include programs that may present a user interface for interaction with a user or that may run in the background of an operating environment that may not present a user interface while in the background. The term “operating system” is defined as a collection of software components that directs a computing device's operations, including controlling and scheduling the execution of other programs and managing storage, input/output and communication resources. A “processing unit” or “processor” is defined as one or more components that execute sets of instructions, and the components may be disparate parts or part of a whole unit and may not necessarily be located in the same physical location. The terms “memory,” “memory element” or “repository” are defined as one or more components that are configured to store data, either on a temporary or persistent basis. The term “shared memory” is memory, a memory element or a repository that is accessible (directly or indirectly) by two or more applications or other processes. An “interface” is defined as a component or a group of components that enable(s) a device to communicate with one or more different devices, whether through hard-wired connections, wireless connections or a combination of both. An “input device” is defined as a device that is configured to receive input from a user or a machine that is intended to cause some action or other effect on a component with which the input device is associated.

The term “file system” is defined as an abstraction that is used to organize, store and retrieve data. The term “secure application” is defined as an application that has been modified or enhanced from its original form to restrict communications between the application and unauthorized programs, applications or devices and to restrict operation of the application based on policy or to alter, augment or add features associated with the operation of the application (or any combination thereof) or—in the case of the application not being modified—an application that is part of a secure workspace that is protected from data exchanges with applications that are part of a personal or an unsecure workspace. A “target application” is defined as an application that has been selected for conversion into a secure application. A “non-secure application” is defined as an application that has not undergone the modification required to convert the application into a secure application and, as such, is unable to obtain data from a secure application in view of an obfuscation scheme employed by that secure application or is an application that is not part of a secure workspace and is restricted from accessing data from the secure workspace. The term “secure framework” is defined as a framework that is configured to encapsulate a secure application by at least preventing the secure application from processing requests from a non-secure application or by otherwise selectively controlling processing requests to or from the secure application. A “virtual machine” is defined as a platform-independent execution environment that emulates a physical machine.

The term “application whitelist” is defined as a listing of one or more non-secure applications or other non-secure programs or components that are authorized to have their requests processed by one or more secure applications to which the application whitelist is attached or assigned. The term “personal workspace” is defined as a workspace, profile or partition that is configured to contain the personal content and non-secure applications or other non-secure programs associated with a user of a computing device on which the personal workspace sits. The term “secure workspace” is defined as a workspace, profile or partition that is configured to contain secure content, secure applications and other secure programs and requires some form of authentication to be accessed.

As explained earlier, solutions have been developed to enable employees of an enterprise to carry mobile devices that include both enterprise and personal data, with the enterprise data being isolated from the personal data. As part of these solutions, one or more secure applications may be installed on an employee's mobile device that also includes one or more non-secure applications. To protect the enterprise data, such an arrangement prevents the secure applications from processing the requests from non-secure applications in a blanket and indiscriminate fashion.

In some cases, it may be desirable to selectively permit a secure application to process a request from a non-secure application. Such an event, however, should not compromise the security of the enterprise data on the mobile device. A method and system that overcome this issue are described herein. In particular, the method can be practiced in a system that supports an environment designed to restrict secure applications from processing requests from non-secure applications. A request can be received from a non-secure application by a system framework and, through the system framework, it can be determined that a secure application is capable of processing the request. The request can be delegated from the system framework to a secure framework. In addition, through the secure framework, it can be determined whether the non-secure application is an authorized non-secure application. If the non-secure application is an authorized non-secure application, the secure application can be permitted to process the request from the non-secure application.

Through this arrangement, a secure application can process requests from non-secure applications, including in the restrictive environment mentioned above. Moreover, because the non-secure applications are pre-approved beforehand, the security of the system can be maintained.

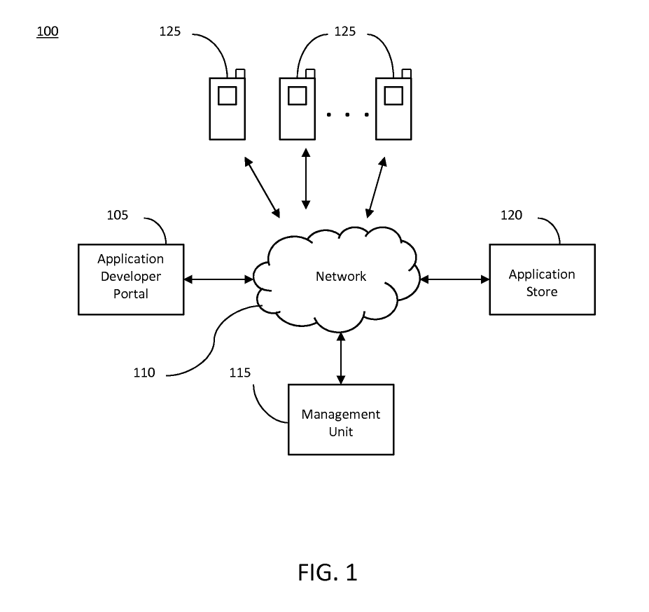

Referring to FIG. 1, a system 100 that is useful for distributing applications is shown. In one arrangement, the system 100 can include an application developer portal 105, a network 110, a management unit 115, an application store or repository 120 and any number of computing devices 125. Although not shown here, the system 100 can include multiple application developer portals 105, networks 110, management units 115 or application stores 120. Also, while FIG. 1 implies that the computing device 125 is a mobile unit, the system 100 and the processes described herein may be relevant to and practiced with fixed computing devices.

The application developer portal 105 can present an interface that enables developers of applications to upload their applications for eventual publication in the application store 120. The application store 120, as is known in the art, can enable users of the portable computing devices 125 to install such published applications on their devices 125. In some cases, the applications from the application developers may be directed to the management unit 115 prior to being published in the application store 120. Through the management unit 115, the applications may be modified such that they are more conducive for operation on behalf of an enterprise or other organization. For example, the applications may be converted into secure applications, a process in which certain intercepts may be imposed on an application such that functions of the application may be restricted, enhanced or otherwise modified in some way, depending on input from the enterprise. Examples of this process are known in the art, and additional information may be obtained from U.S. Pat. No. 8,695,060, issued on Apr. 8, 2014; U.S. Patent Application Publication No. 2014/0096230, filed on Sep. 25, 2013; U.S. patent application Ser. No. 14/205,661, filed on Mar. 12, 2014; U.S. patent application Ser. No. 14/205,686, filed on Mar. 12, 2014; U.S. Patent Application No. 62/033,142, filed on Aug. 5, 2014; U.S. patent application Ser. No. 14/614,866, filed on Feb. 5, 2015; and U.S. Patent Application No. 62/119,586, filed on Feb. 23, 2015, each of which is herein incorporated by reference in its entirety. An application that has been selected for conversion into a secure application by the management unit 115 (or some other component) may be referred to as a target application. In addition, an application that has not undergone the process of conversion into a secure application may be referred to as a non-secure application.

Once a secure application is generated, it can be published in the application store 120, similar to a conventional application that has been published. Because the application store 120 accepts and offers secure applications, it may also be referred to as a secure application store 120. In some cases, the secure application store 120 may be configured to accept and offer only secure applications or other enterprise applications, although in other scenarios it may accept and offer both secure and non-secure applications. In addition, the secure application store 120 may have limited access to a certain group of users, such as those associated with a particular enterprise, or it may be open to the general public. If access is limited to the secure application store 120, an accessing user (or device 125) may be required to provide some form of authentication before being granted such access. Moreover, the applications that are made available through the secure application store 120 are not necessarily required to be received from the application developer portal 105, as other sources may be used to provide applications to the secure application store 120.

The network 110 can facilitate communications between any of the components of the system 100. As mentioned earlier, there may be multiple networks 110 in the system 100, and each network 110 may be composed of various types of components to support wireless or wired communications (including both). In addition, the network(s) 110 may be configured to support both local or wide area communications (or both).

In one arrangement, the management unit 115 may serve as a remote portal that can be used to manage certain features or operations of the computing devices 125. For example, as will be explained in more detail below, the management unit 115 can provide information to the computing devices 125 to enable the secure applications on a computing device 125 to process requests from non-secure applications.

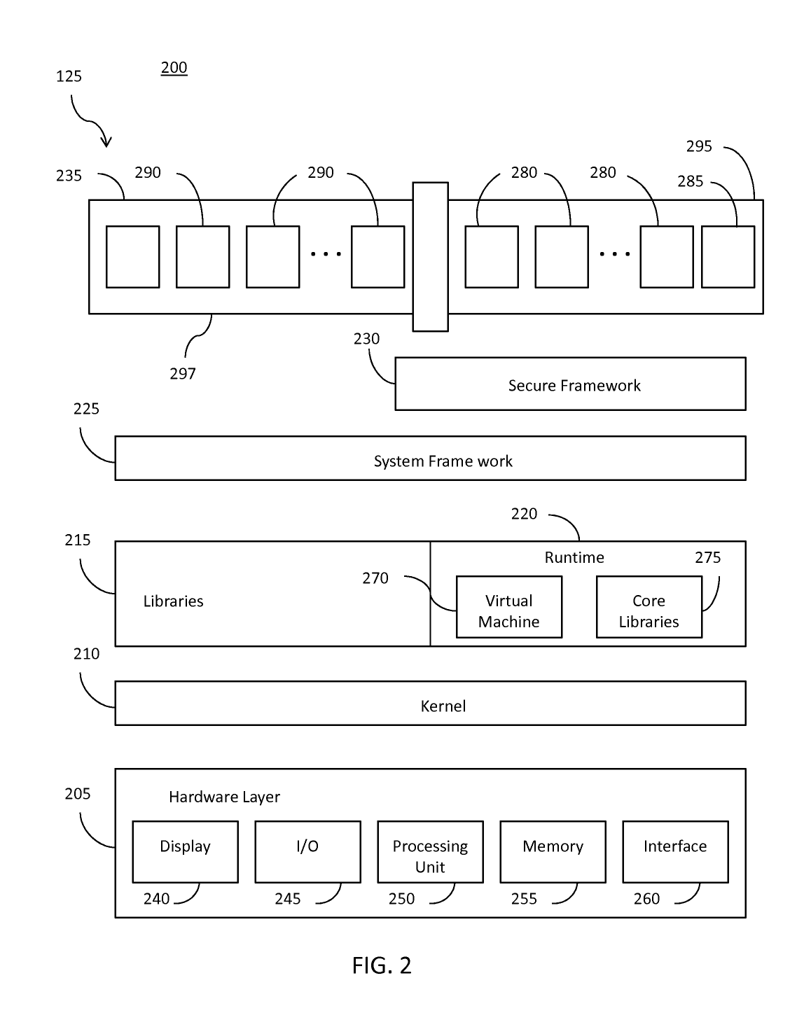

Referring to FIG. 2, an example of a block diagram 200 of the system architecture of a computing device 125 is shown. In this arrangement, the computing device 125 can include a hardware layer 205, a kernel layer 210 and a libraries layer 215, which may include a plurality of native libraries. This architecture may also include a runtime environment 220, a system framework 225, a secure framework 230 and an application layer 235.

In one arrangement, the hardware layer 205 may include any number and type of hardware components, such as one or more displays 240, one or more input/output (I/O) devices 245, one or more processing units 250 and any suitable type and number of memory devices 255 and interfaces 260. Examples of I/O devices include speakers, microphones, physical keypads, etc. The interfaces 260 can be configured to support various types of communications, including wired or wireless and through any suitable type of standards and protocols.

In addition, the runtime environment 220 can support any suitable number of virtual machines 270 and core libraries 275, and the system framework 225 can serve as an abstraction for the underlying layers for the applications in the application layer 235. The secure framework 230 can function similar to that of a conventional framework, but the secure framework 230 can facilitate the encapsulation of a number of secure applications to prevent them from handling requests from non-secure applications, except if the non-secure applications have been previously authorized.

The application layer 235 may have one or more secure applications 280, one of which may be a secure personal information manager (PIM) application 285. In one arrangement, the secure PIM application 285 may be comprised of one or more other secure applications 280, each of which may be related to certain types of core secure data, like secure contacts, secure calendars and secure tasks. The application layer 235 may also have one or more non-secure applications 290. In many cases, the non-secure applications 290 are associated with the personal data of a user of the computing device 125. In one arrangement, a virtual partition may be created on the computing device 125 in which the secure applications 280 (and the PIM application 285) are part of a secure workspace 295, and the non-secure applications 290 are part of a personal workspace 297. In certain cases, a user may be required to provide authentication information, such as a password, PIN or biometric data, to gain access to the secure workspace 295 or to any individual or group of secure applications 280. In addition, the user may launch both secure applications 280 and non-secure applications 290 through an I/O device 245.

As referenced earlier, for security reasons, the system 200 may be an environment that is designed to restrict secure applications 280 from processing requests from non-secure applications 290. For example, under the original design, a non-secure application 290, such as a dialer, may be prevented from showing the details associated with a secure contact (part of a secure contacts application 280) if a call should come in from a number associated with that secure contact.

To overcome this issue, a non-secure application 290 may be pre-approved for such a request. For example, the non-secure application 290 may be part of an authorized list that permits a secure application 280 to process the request from the non-secure application 290. In one arrangement, the authorized list may be an application whitelist that can be part of a database that is associated with the secure PIM application 285. Additional detail on this process will be presented below.

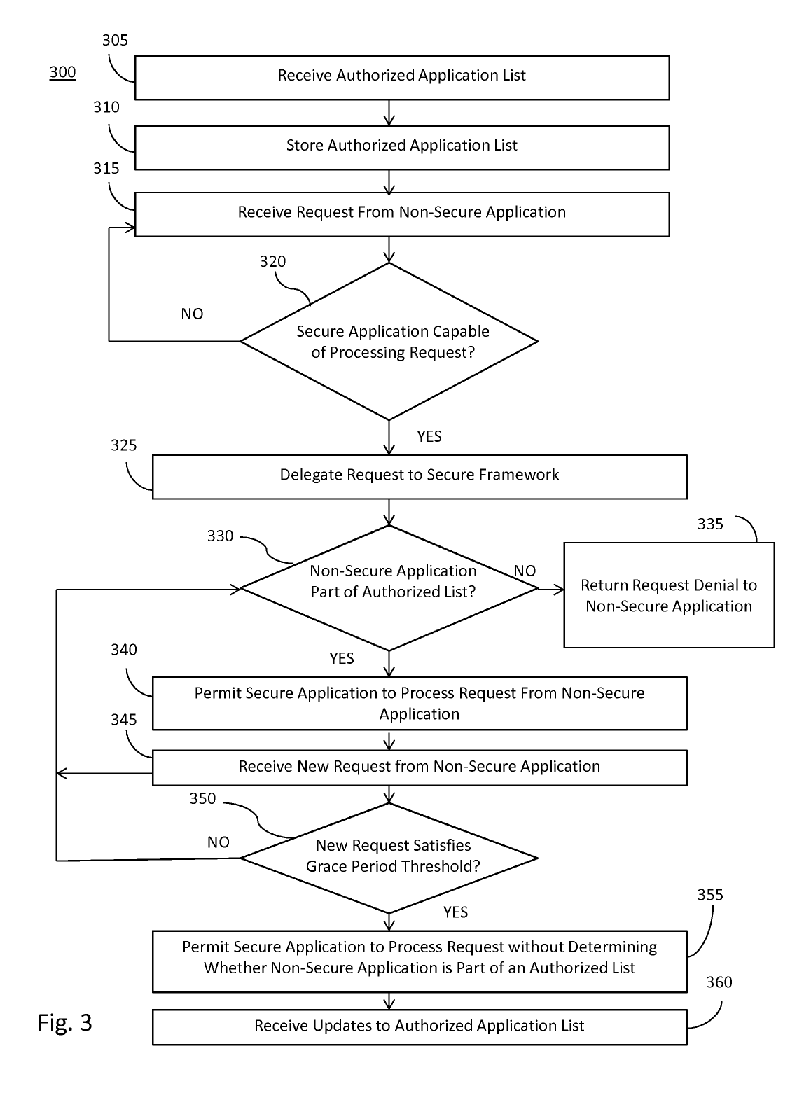

Referring to FIG. 3, an exemplary method 300 for selectively permitting a non-secure application to communicate with a secure application is shown. The method 300, however, may include additional or even fewer steps or processes in comparison to what is illustrated in FIG. 3. Moreover, the method 300 is not necessarily limited to the chronological order that is shown in FIG. 3. In describing the method 300, reference may be made to FIGS. 1, 2 and 4, although it is understood that the method 300 may be practiced with any other suitable systems and components and may take advantage of other suitable processes.

At step 305, an authorized application list may be received, and the authorized application list may be stored, as shown at step 310. For example, the computing device 125, as described earlier, may include secure applications 280 and non-secure applications 290. When a non-secure application 290 is installed on the computing device 125, the non-secure application 290 may register with the system framework 225 of the device 125, which can provide the system framework 225 with important information about the non-secure application 290. For example, the non-secure application 290 may include a manifest file in its root directory that identifies and describes the components of the non-secure application 290. As a result, if the system framework 225 receives a request from a second non-secure application 290, the system framework 225 can compare the contents of the request with the information that the system framework 225 obtained when the previous non-secure application 290 was registered. If there is a match, the system framework 225 can start the relevant component of the previous non-secure application 290 and deliver the request to the previous non-secure application 290.

The process that occurs when a secure application 280 is installed on the computing device 125 can leverage this scheme to enable inter-app communications, albeit with several notable differences. As is known in the art, a secure application 280 may have intercepts imposed on certain components of the secure application 280, whether pre-installation or at runtime of the secure application 280. For those components that do not have intercepts imposed on them, the system framework 225 may be made aware of such components through a manifest of the secure application 280. That is, there are certain components of the secure application 280 that may not be encapsulated to permit the secure application 280 to take advantage of the features of the operating system. In contrast, for those components of the secure application 280 that are to be encapsulated from the general operating processes of the computing device 125, a registration process can be conducted with the secure framework 230 for such components. These components can also be identified and described in the manifest of the secure application 280.

If a secure application 280 generates a request and that request is facilitated by the system framework 225, the request may be processed by a non-secure application 290. The integrity of the secure application 280 may be maintained here because a prior determination was made to identify the components of the secure application 280 that are suitable for interactions with the system framework 225. The encapsulation of the secure applications 280, however, would normally prevent any requests from the non-secure applications 290 from being processed by the secure applications 280.

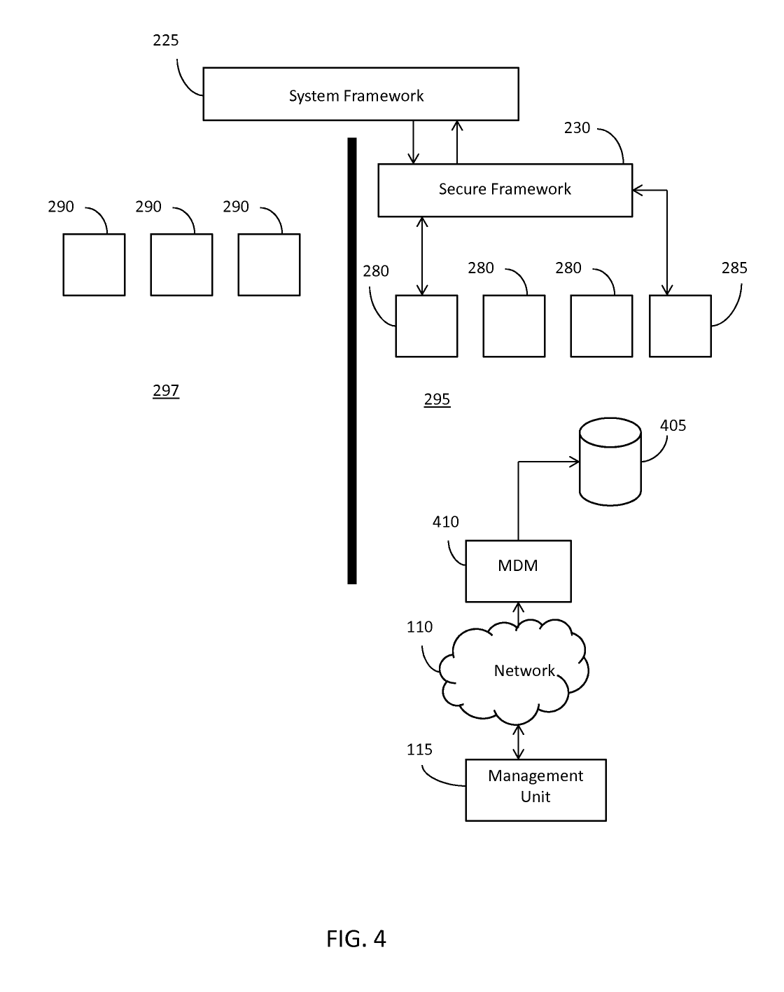

In one arrangement, an authorized application list, or application whitelist, can be prepared and sent to the computing device 125. The application whitelist can identify one or more non-secure applications 290 by their package names, and these non-secure applications 290 may be authorized to have at least some of their requests processed by the secure applications 280. As an example, the application whitelist can be stored locally on the computing device 125. Referring to FIG. 4, an example of a portion of the system architecture of FIG. 2 is shown. In this case, the application whitelist can be stored in a database 405 that is associated with the secure PIM application 285, and the database 405 may be a part of the memory 255 of FIG. 2. Of course, other suitable components can serve to store the application whitelist, including at locations that are remote to the computing device 125.

Referring back to FIG. 3, at step 315, a request can be received from a non-secure application, and at decision block 320, a determination can be made as to whether the secure application is capable of processing the request. If not, the flow may resume at step 315. If it can, the request from the non-secure application may be delegated from the system framework to the secure framework, as shown at step 325. At decision block 330, a determination can be made as to whether the requesting non-secure application is part of the authorized application list. If it is not, a request denial can be returned to the non-secure application, as shown at step 335. If the non-secure application is authorized, however, the secure application can be permitted to process the request from the non-secure application, as shown at step 340.

For example, referring to FIG. 4, when a secure application 280 is installed, certain components of the secure application 280 may be registered with the system framework 225, similar to the description above. These components of the secure application 280 may be configured to process requests that may be facilitated by the system framework 225. As such, when the system framework 225 receives a relevant request from the non-secure application 290, the system framework 225 can determine that the request matches a declaration from the secure application 280. At this point, the system framework 225 can delegate the request to the secure framework 230.

The secure framework 230 can then determine if the requesting non-secure application 290 is an authorized non-secure application 290. In particular, the secure framework 230, aware of the identity of the non-secure application 290 through the request, can check the application whitelist in the database 405. If the non-secure application 290 is part of the application whitelist, the secure framework 230 can allow the request to pass to the appropriate secure application 280 for processing. If, however, the requesting non-secure application 290 is not part of the application whitelist, the secure framework 230 can return a request denial to the non-secure application 290, through the system framework. Accordingly, the secure application 280 can register with the system framework 225 to process certain types of events from the non-secure applications 290, yet the integrity of the secure application 280 can be maintained because only those requests from authorized non-secure applications 290 may be allowed to be processed. This feature may be useful when a commonly-used non-secure application 290 may need protected information from a secure application 280, such as secure contact information for a dialer application for purposes of caller ID.

In one arrangement, the application whitelist may be applicable to all secure applications 280 that are part of the secure workspace 295. As such, this whitelist may be consulted for any requests from non-secure applications 290 that are meant for processing by any secure application 280 on the computing device 125. In another arrangement, multiple application whitelists may be maintained for different groupings of secure applications 280, including for individual secure applications 280. That is, an application whitelist may be unique to an individual secure application 280 or to a group of secure applications 280. Through this feature, greater granularity can be achieved in the handling of the requests from the non-secure applications 290.

Referring once again to FIG. 3, at step 345, a new request can be received from the non-secure application. In one option, the method 300 can be directed to decision block 330, where the process of determining whether the non-secure application is an authorized non-secure application may be repeated. In another option, the method 300 may be directed to decision block 350, where a determination can be made as to whether the new request satisfies a grace period threshold. If it does not, the method 300 can resume at decision block 330, where it can be determined whether the non-secure application is part of an authorized list. Conversely, if the new request satisfies the threshold, the secure application can be permitted to process the request without repeating the process of determining whether the non-secure application is an authorized non-secure application by checking the authorized list, as shown at step 355.

For example, if the system framework 225 receives a new request from the same or a different non-secure application 290, the process described above can be repeated. That is, each time a request is received, the requesting non-secure application 290 can be checked against the authorized application list.

In some cases, however, an abbreviated process may be carried out. For example, the secure framework 230 (or some other component) can timestamp an initial request from a particular non-secure application 290 that is part of the authorized list. If a new request is received, it can be compared to the timestamp for the initial request. If the new request is within a grace period threshold, the secure framework 230 can permit the new request to pass to the appropriate secure application 280 without having to check the authorized list again. If the new request is outside the grace period threshold, however, the secure framework 230 can check the authorized list, as presented above.

The grace period threshold, such as in the example presented here, can be a set period of time. In another example, however, the threshold can be based on a counter such that a set number of requests from a non-secure application 290 may be processed without having to check the authorized list. Once the number of requests from the non-secure application 290 exceeds the predetermined grace period threshold, the secure framework 230 can resort to checking the authorized list for the next request from the non-secure application 290. In either case, once the non-secure application 290 is again determined to be an authorized non-secure application 290, the grace period (timer or counter) can be reset.

As explained above, the grace period permits secure applications 280 to process new requests from a non-secure application 290 without having to check the authorized list. In one example, this feature may only apply to the same non-secure application 290 such that any new request from a different non-secure application 290 will need to be checked against the authorized list. In another example, however, this feature may apply to new requests from different non-secure applications 290. In particular, an initial request may be compared against the authorized list, and a grace period may be implemented for new requests. The new request may be from a different non-secure application 290, such as one whose certificate has been signed by the same entity as the non-secure application 290 that issued the initial request that started the grace period. Because there is some relation between these non-secure applications 290, the grace period may apply to subsequent requests from either of them. Of course, the different non-secure applications 290 may be related in some other fashion, such as being selected by an enterprise responsible for or otherwise associated with the secure applications 280 (or non-secure applications 290) or may not even be related at all.

Referring back to FIG. 3 again, at step 360, updates can be received for the authorized application list. For example, the authorized list may be dynamic in nature, meaning that non-secure applications may be added to or removed from the authorized list. Referring to FIG. 4, a remote portal, such as one supported by the management unit 115, can be used to provide updates to the authorized list. For example, selections for approved non-secure applications 290 may be made at the management unit 115, and these selections may be sent through the network 110 and processed by a mobile device management (MDM) client 410 that is part of the computing device 125. As part of this feature, the updates may be received by an interface 260 of FIG. 2. This arrangement presents a convenient manner in which the authorized list may be updated to account for changes in certain policies or security risks.

One skilled in the art will appreciate that the processes described herein, particularly those of FIG. 3, may be under the direction of, facilitated by or at least assisted by one or more of the processing units 250 of FIG. 2. Other circuitry and hardware components of the computing device 125 may also provide such support. In addition, the processes described herein may also apply to other enterprise applications, including those that may not necessarily be secure applications but may be designated by an enterprise or other entity as being subject to selective interaction with other applications.

While various embodiments have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

What is claimed is:

1. A method of selectively permitting a non-secure application to communicate with a secure application, comprising:
in an environment designed to restrict secure applications from processing requests from non-secure applications, receiving a request from a non-secure application by a system framework;
determining, through the system framework, that a secure application is capable of processing the request;
delegating the request from the system framework to a secure framework;
determining, through the secure framework, whether the non-secure application is an authorized non-secure application;
if the non-secure application is an authorized non-secure application, permitting the secure application to process the request from the non-secure application.

2. The method according to claim 1, further comprising returning a request denial to the non-secure application if the non-secure application is not an authorized non-secure application.

3. The method according to claim 1, wherein determining, through the secure framework, whether the non-secure application is an authorized non-secure application comprises determining whether the non-secure application is part of an application whitelist.

4. The method according to claim 3, wherein the application whitelist is unique to the secure application or is assigned to the secure application and other secure applications.

5. The method according to claim 3, wherein the application whitelist is a dynamic whitelist and the method further comprises receiving one or more updates to the application whitelist such that non-secure applications are added to or removed from the application whitelist.

6. The method according to claim 1, further comprising:
receiving a new request from the non-secure application; and
repeating the process of determining whether the non-secure application is an authorized non-secure application before permitting the secure application to process the new request from the non-secure application.

7. The method according to claim 3, further comprising:
receiving a new request from the non-secure application;
determining whether the new request satisfies a grace period threshold; and
if the new request satisfies the grace period threshold, permitting the secure application to process the new request without repeating the determination of whether the non-secure application is an part of the application whitelist.

8. A method of selectively enabling application requests, comprising:
on a computing device that supports an environment that is designed to restrict secure applications from processing requests from non-secure applications, receiving an application whitelist;
storing the application whitelist at the computing device;
receiving a request from a non-secure application;
determining that a secure application is capable of processing the request from the non-secure application;
determining whether the non-secure application is part of the application whitelist; and
if the non-secure application is part of the application whitelist, permitting the secure application to process the request from the non-secure application.

9. The method according to claim 8, wherein storing the application whitelist comprises storing the application whitelist in a database that is associated with a secure personal information manager (PIM) application.

10. The method according to claim 8, further comprising receiving an update to the application whitelist from a remote portal.

11. The method according to claim 8, wherein certain components associated with the secure application have intercepts imposed on them and the method further comprises registering with a system framework of the computing device at least some of the components associated with the secure application that have not had intercepts imposed on them.

12. The method according to claim 8, wherein the secure application interacts with a secure framework and determining whether the non-secure application is part of the application whitelist is performed through the secure framework.

13. The method according to claim 8, wherein the computing device has a personal workspace and a secure workspace and the non-secure application is part of the personal workspace and the secure application is part of the secure partition and wherein the non-secure application is associated with personal data of a user of the computing device and the secure application is associated with enterprise data.

14. A computing device, comprising:
an input device that is configured to accept input from a user that enables the user to launch both secure and non-secure applications, wherein the computing device supports an environment that is designed to restrict the secure applications from processing requests from the non-secure applications;
memory that is configured to store an application whitelist that identifies authorized non-secure applications; and
a processing unit that is configured to:
facilitate the determination that a secure application is capable of processing a request from a non-secure application;
facilitate the determination that the requesting non-secure application is part of the application whitelist; and
facilitate the secure application processing the request from the non-secure application if the non-secure application is identified as part of the application whitelist.

15. The computing device according to claim 14, wherein the processing unit is further configured to facilitate the determination that the secure application is capable of processing the request from the non-secure application through a system framework that is part of the computing device.

16. The computing device according to claim 14, wherein the processing unit is further configured to facilitate the determination that the requesting non-secure application is part of the application whitelist through a secure framework that is part of the computing device.

17. The computing device according to claim 14, wherein the application whitelist is unique to the secure application or is assigned to the secure application and other secure applications.

18. The computing device according to claim 14, further comprising an interface that is configured to receive one or more updates to the application whitelist such that non-secure applications are added to or removed from the application whitelist.

19. The computing device according to claim 14, wherein the processing unit is further configured to facilitate the registration of certain predetermined components of the secure application with a system framework of the computing device.

20. The computing device according to claim 14, wherein the computing device is configured to support a personal workspace and a secure workspace and the non-secure application is part of the personal workspace and the secure application is part of the secure workspace.
